(19) United States
(12) Patent Application Publication
(10) Pub. No.: US 2012/0182160 A1
(43) Pub. Date: Jul. 19, 2012

(54) Directional Vehicle Sensor Matrix

(75) Inventor: Arie Hod, Richmond Hill (CA)

(73) Assignee: TCS International, Inc., Sudbury, MA (US)

(21) Appl. No.: 13/007,069

(22) Filed: Jan. 14, 2011

(51) Int. Cl. G08G 1/01

(52) U.S. Cl. 340/934; 340/933; 340/936

(57) ABSTRACT

An apparatus, method, and system for detecting and counting vehicles on a roadway are presented. The roadway need not be partitioned into directional lanes. The matrix may have a plurality of matrix elements in communication with a master matrix element. Each matrix element contains two sensors, a processor and a transceiver. Matrix elements transmit sensor data to the master matrix element, which uses the sensor data to calculate the number of vehicles traveling through the detection area of the sensor matrix, and the point of entry and the point of exit of each such vehicle.

### FIELD OF THE INVENTION

The present invention relates to sensor technology, and more particularly, is related to vehicle sensors.

### BACKGROUND

There are many situations where collection of traffic data may be required. Urban planners may wish to determine the usage of specific roadways to decide when lane expansions or traffic signals are needed. Detection of traffic conditions may be used to divert drivers to less congested routes. Parking facility managers may wish to monitor when vehicles enter or exit a parking area, for example, to determine availability of parking spaces.

Vehicle sensors may be used to detect automotive traffic in roadways. Such vehicle sensors may use a variety of technologies. For example, pneumatic tubes or hoses may be placed across a roadway to detect the pressure of a vehicle as its tires roll over the tubes or hoses. In another example, an optical light beam emitter and sensor system may detect a vehicle when the vehicle interrupts a light beam projected across a roadway. In addition, in-ground inductance loops may detect a vehicle in close proximity by detecting a change in magnetic inductance. Other examples of vehicle detection sensors include optical detectors and ultrasound detectors.

Vehicle detectors may be installed under the surface of a roadway or may be mounted upon the surface of the roadway. Under surface installation of large inductive loop sensors may be time consuming and expensive, as it generally requires cutting into large sections of a hard roadway surface such as cement, concrete or asphalt. Such installation procedures are labor intensive and disruptive to traffic, and may damage the surface of the roadway. Surface mounted sensors must be durable enough to withstand being run over by vehicles, and must similarly be resistant to weather conditions, water, sand, and dirt.

Prior art traffic sensors have several limitations. For example, many sensors merely detect whether an object is present within the field of detection of the sensor. However, the sensor may not be able to detect whether the vehicle is moving or stationary, or indeed whether there is a single vehicle or multiple vehicles present.

Prior art traffic sensors capable of detecting moving vehicles have been limited by the requirement that a vehicle be restricted to a defined lane. For example, if a roadway has multiple lanes to accommodate vehicles traveling the same direction, a sensor may only be able to detect vehicles within a single lane. Further, if a vehicle is occupying more than one lane, for example, if the vehicle is changing lanes at the sensor location, a sensor for each lane may simultaneously detect the vehicle, thereby double counting the vehicle. If a vehicle is turning in the vicinity of one or more sensors, each sensor may only detect a portion of the vehicle as it turns through the detection area of each sensor, making it difficult to determine both the number of vehicles and the direction each vehicle is traveling.

Facilities employing such lane specific traffic sensors have heretofore resorted to various means to restrict vehicles to remain within their lanes in the location where the vehicles are detected by sensors. Simple visual methods, such as painting lane lines, may be ignored by vehicle drivers. More obstructive means, such as erecting posts or barriers to restrict vehicles to their lanes when in the vicinity of the sensors may also be problematic. For example, vehicles may collide with the barriers, or the barriers may interfere with traffic flow in confined areas, such as a parking garage. Such measures may require periodic replacement of the barriers, and may lead to vehicle damage.

Another problem may occur when two or more vehicles are present in the detection area of a sensor at the same time. For example, if one vehicle is very close behind a second vehicle (i.e., tailgating) when the vehicles pass near a sensor, the sensor may detect only one vehicle. For another example, two vehicles may be traveling in opposite directions at the time they are both within the detection area of the sensor, resulting in incorrect vehicle detection.

Some sensor systems may detect the speed and velocity of a vehicle by sensing the vehicle at two or more locations. The speed may be determined by dividing the distance between the two sensor fields by the time the vehicle took to traverse the distance between the two detectors. In general, these systems are restricted to single lanes, as, for example, the detection of a vehicle by a first detector in a first lane and the detection of the same vehicle by a second detector in a second lane may not be correlated. Similar problems arise when speed and velocity detectors encounter vehicles traveling in opposite directions.

In addition, prior art sensors are generally not adaptable for differently sized roadways. For example, a sensor may have a specific area range. In order to expand that range, the sensor has generally needed to be replaced by another sensor having a range configured for the larger roadway.

Therefore, there is an unmet need for traffic sensors capable of detecting the speed and direction of vehicles in a detection area without restricting vehicles to predetermined lanes. Further, there is a need to detect distinct vehicles when two closely spaced vehicles pass through a detection area, to detect two or more vehicles simultaneously passing through the detection area in different directions, and to detect a vehicle changing direction within the detection area. Finally, there is a need for a directional traffic sensor having a modular design able to network to provide extended vehicle detection coverage for a variety of roadway sizes and conditions.

### SUMMARY

Accordingly, a first aspect of the present invention is directed to an apparatus for detecting a vehicle traversing a non-partitioned monitored roadway. The apparatus includes a first sensor matrix element. The first sensor matrix element includes a first sensor matrix element first sensor monitoring a first detection area within the monitored roadway, the first sensor configured to communicate sensor data. The first sensor matrix element includes a first sensor matrix element second sensor monitoring a second detection area within the monitored roadway. The first sensor matrix element second sensor is configured to communicate sensor data. The second detection area is substantially adjacent to the first detection area. The first sensor matrix element includes a first sensor matrix element processor in communication with the first sensor matrix element first sensor and the first sensor matrix element second sensor. The first sensor matrix element further includes a first sensor matrix element transceiver in communication with the first sensor matrix element processor.

The apparatus of the first aspect includes a second sensor matrix element in communication with the first sensor matrix element. The second sensor matrix element includes a second sensor matrix element first sensor monitoring a third detection area within the monitored roadway. The second sensor matrix element first sensor is configured to communicate sensor data, with the third detection area being substantially adjacent to the first detection area. The second sensor matrix element includes a second sensor matrix element second sensor monitoring a fourth detection area within the monitored roadway. The second sensor matrix element second sensor is configured to communicate sensor data. The second sensor matrix element includes a second sensor matrix element processor in communication with the second sensor matrix element first sensor and the second sensor matrix element second sensor. The second sensor matrix element includes a second sensor matrix element transceiver in communication with the second sensor matrix element processor.

In addition, the first sensor matrix element may be configured to transmit sensor data to the second sensor matrix element, and the first sensor matrix element may be configured as a slave and the second sensor matrix element may be configured as a master. The first sensor matrix element may be in wireless communication with the second sensor matrix element. Alternatively, the first sensor matrix element may be in wired communication with the second sensor matrix element. The first sensor matrix element may be configured to be mounted above the first detection area and the second detection area, and the first sensor matrix element first sensor may include an ultrasonic sensor, where the first sensor matrix element first sensor and the first sensor matrix element second sensor may be contained within a single housing. Alternatively, the first sensor matrix element first sensor may include a magnetic field sensor mounted beneath the monitored roadway. The magnetic field sensor may communicate wirelessly with the first sensor matrix element processor, and the first sensor matrix element first sensor and the first sensor matrix element second sensor may not be housed within a single enclosure.

A second aspect of the present invention is directed to a method for directionally detecting vehicles traversing a non-partitioned monitored roadway between a first vehicle area and a second vehicle area. The method includes several steps, including providing a first sensor matrix element within the monitored roadway. The first sensor matrix element has a first sensor matrix element first sensor and a first sensor matrix element second sensor. A step includes providing a second sensor matrix element within the monitored roadway. The second sensor matrix element has a second sensor matrix element first sensor and a second sensor matrix element second sensor.

Another step includes establishing a communications link between the first sensor matrix element and the second sensor matrix element. Steps include detecting a vehicle with the first sensor matrix element, detecting the vehicle with the second sensor matrix element, transmitting vehicle detection data from the first sensor matrix element to the second matrix element, and correlating vehicle detection data from the first sensor matrix element with vehicle detection data from the second sensor matrix element. Further steps are calculating a vehicle entrance location into the monitored roadway, and calculating a vehicle exit location from the monitored roadway.

Additional steps may include wirelessly transmitting vehicle detection data, calculating a vehicle speed, calculating a vehicle length, calculating a vehicle height, and calculating a number of vehicles traversing the monitored roadway. The number of vehicles traversing the monitored roadway may include a count of vehicles entering the first vehicle area, a count of vehicles entering the second vehicle area, a count of vehicles exiting the first vehicle area, and a count of vehicles exiting the second vehicle area. The method may include discerning a vehicle from a non-vehicle in the monitored roadway, or discerning a first vehicle in the monitored roadway from a second vehicle in the monitored roadway, where the second vehicle is separated from the first vehicle by at least two feet.

A third aspect of the present invention includes a computer readable media configured to perform steps including receiving a first data message from a local sensor, where the local sensor is configured to detect a vehicle within a first portion of a non-partitioned monitored roadway. A step includes receiving a second data message from a remote sensor, the remote sensor configured to detect a vehicle within a second portion of the monitored roadway. Steps also include correlating the first data message with the second data message, and calculating a number of vehicles traversing the monitored roadway. The number of vehicles traversing the monitored roadway includes a count of vehicles entering a first vehicle area adjacent to the monitored roadway, a count of vehicles entering a second vehicle area adjacent to the monitored roadway, a count of vehicles exiting the first vehicle area, and a count of vehicles exiting the second vehicle area.

The computer readable media of the third aspect may further be configured to perform steps including calculating a speed of a vehicle traversing the monitored roadway, calculating a length of the vehicle, calculating a height of the vehicle, and discerning a vehicle from a non-vehicle in the monitored roadway. The computer readable media may be further configured to perform the step of discerning a first vehicle in the monitored roadway from a second vehicle in the monitored roadway, wherein the second vehicle is separated from the first vehicle by at least two feet.

A fourth aspect of the present invention is a method for directionally detecting vehicles traversing a non-partitioned monitored roadway between a first vehicle area and a second vehicle area. The method includes providing a first sensor within the monitored roadway, where the first sensor includes a wireless transceiver, providing a second sensor within the monitored roadway, where the second sensor includes a wireless transceiver, and providing a processor including a wireless transceiver. The method includes the steps of establishing a communications link between the first sensor and the processor, establishing a communications link between the second sensor and the processor, detecting a vehicle with the first sensor, detecting a vehicle with the second sensor, transmitting vehicle detection data from the first sensor to the processor, transmitting vehicle detection data from the second sensor to the processor, and correlating vehicle detection data from the first sensor with vehicle detection data from the second sensor.

The method of the fourth aspect may also include the steps of calculating a vehicle entrance location into the monitored roadway, and calculating a vehicle exit location from the monitored roadway. Steps may include calculating a vehicle speed, calculating a vehicle length, or calculating a number of vehicles traversing the monitored roadway. The number of vehicles traversing the monitored roadway may include a count of vehicles entering the first vehicle area, a count of vehicles entering the second vehicle area, a count of vehicles exiting the first vehicle area, and a count of vehicles exiting the second vehicle area. The method may also include the step of discerning a vehicle from a non-vehicle in the monitored roadway, or discerning a first vehicle in the monitored roadway from a second vehicle in the monitored roadway, wherein the second vehicle is separated from the first vehicle by at least two feet.

A fifth aspect of the present invention is a system for monitoring vehicle presence within a vehicle area. The system includes a first directional vehicle sensor matrix located substantially within a first vehicle area portal. The first directional vehicle sensor matrix includes a first sensor matrix element having a first sensor matrix element first sensor monitoring a first detection area within the portal, and a first sensor matrix element second sensor monitoring a second detection area within the portal. The system includes a second sensor matrix element in communication with the first sensor matrix element, and a vehicle area manager in communication with the first directional vehicle sensor matrix. The vehicle area manager includes a database, and the database includes a vehicle occupancy count for the vehicle area. The first sensor matrix element and the second sensor matrix element may communicate wirelessly. Likewise, the first directional vehicle sensor matrix and the vehicle area manager may communicate wirelessly. A vehicle area display may be in communication with the vehicle area manager, and the vehicle area display may be configured to display the vehicle occupancy count. The vehicle area manager and the vehicle area display may communicate wirelessly. Similarly, the first directional vehicle sensor matrix may be in communication with the vehicle area display, and the first directional vehicle sensor matrix and the vehicle area display may communicate wirelessly.

The system of the fifth aspect may include a second directional vehicle sensor matrix located substantially within a second vehicle area portal. The first directional vehicle sensor matrix may be in communication with the second directional vehicle sensor matrix, and the first directional vehicle sensor matrix and the second directional vehicle sensor matrix may communicate wirelessly.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principals of the invention.

FIG. 1 is a schematic diagram showing a first embodiment of a sensor matrix element with ultrasonic sensors.

FIG. 2 is a schematic diagram showing an exemplary implementation of the first embodiment of the sensor matrix element.

FIGS. 3A and 3B are schematic two diagrams showing an exemplary implementation of the first embodiment of a directional sensor matrix with three sensor matrix elements.

FIGS. 4A, 4B and 4C are schematic diagrams showing exemplary paths of a vehicle traversing a roadway monitored by an exemplary implementation of the first embodiment of a directional sensor matrix with three sensor matrix elements.

FIG. 5 is a simplified block diagram of the functional elements of the first embodiment of the sensor matrix element 100.

FIG. 6 is a timing diagram showing an example of the synchronization messages between a master and a slave sensor matrix element.

FIG. 7 is a schematic diagram of a parking garage monitoring system with multiple directional vehicle sensor matrixes.

FIG. 8, is a flow chart depicting the initial processing in master and slave matrix elements.

FIG. 9 is a flow chart depicting the processing in slave matrix elements.

FIG. 10 is a flow chart depicting the processing in master matrix elements.

FIG. 11 is a flow chart depicting vehicle direction detection processing.

FIG. 12 is a schematic diagram showing an exemplary implementation of the second embodiment of a sensor matrix element.

### DEFINITIONS

As used herein, a vehicle area is a region where vehicles may be located, for example, a parking area or a roadway. For exemplary purposes, the region is described herein as including the airspace up to 10 meters above the roadway surface, as well as the area extending down to one meter beneath the roadway surface. One having ordinary skill in the art will appreciate that different measurements may be included as being within the vehicle area depending upon the specific sensor technology being used. As used herein, the term portal refers to a vehicle entrance to a vehicle area and/or a vehicle exit from a vehicle area. As used herein, the term “partitioned roadway” refers to a roadway that has been separated into distinct directional lanes, so that vehicle traffic within a partitioned lane generally travels in a uniform direction. Such partitioning may be by non-physical means, for example, by painted lane lines, or by physical means, such as poles, fences or other physical barriers. Conversely, as used herein, the term “non-partitioned roadway” refers to a roadway where vehicle traffic is not necessarily restricted to traveling within uniform directional lanes.

### DETAILED DESCRIPTION

Reference will now be made in detail to embodiments of the present invention, examples of which are illustrated in the accompanying drawings. Wherever possible, the same reference numbers are used in the drawings and the description to refer to the same or like parts.

A directional vehicle sensor matrix is presented. The vehicle sensor matrix may be positioned to monitor a vehicle area portal. The matrix may have a plurality of sensor matrix elements in communication with a master matrix element. Each sensor matrix element includes two sensors, a processor and a transceiver. Sensor matrix elements may transmit sensor data to the master matrix element, which uses the sensor data to calculate the number of vehicles traveling through a vehicle area portal, and the portal entry and exit location of each detected vehicle.

### Sensor Matrix Element

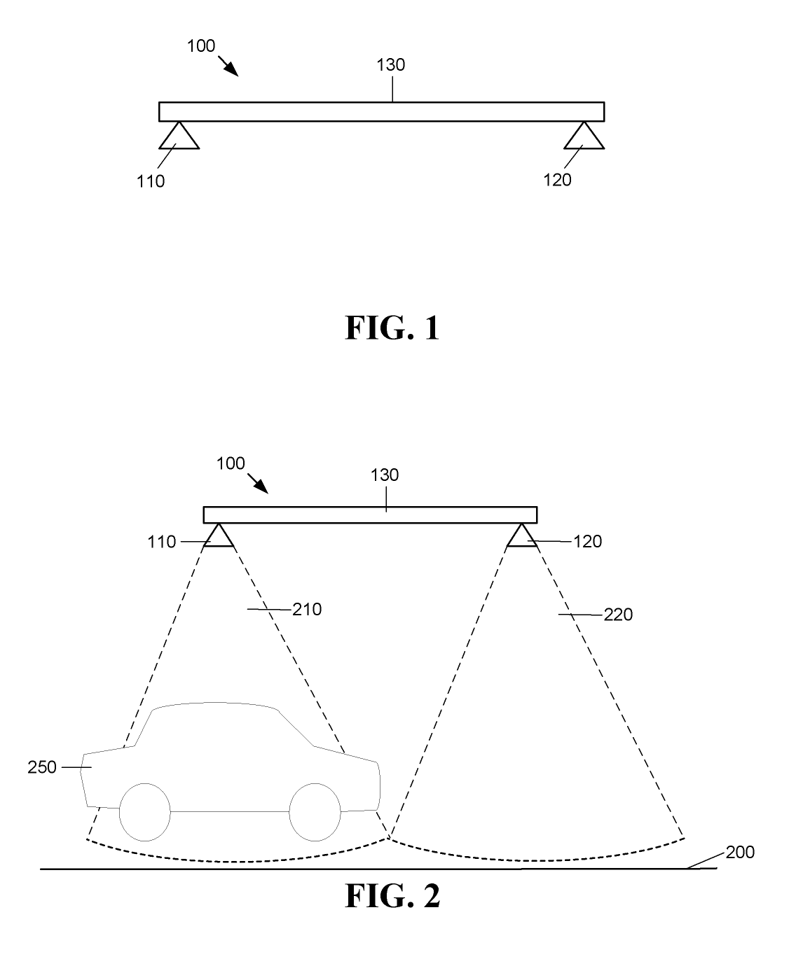

FIG. 1 is a simplified schematic diagram of a first embodiment of a sensor matrix element 100. The sensor matrix element 100 includes a first sensor 110 mounted substantially at a first end of a sensor matrix element housing 130, and a second sensor 120 mounted substantially at a second end of the sensor matrix element housing 130. The sensor elements in the first embodiment are ultrasound sensors, for example, ultrasonic directional sensors (USDS). However, other types of sensors, for example, magnetic sensors, are also within the scope of this disclosure.

FIG. 2 is a schematic diagram of the first embodiment of the sensor matrix element 100 mounted above a roadway 200. As an example, some roadway 200 may be the entryway of a parking garage level. The first sensor 110 may detect vehicles entering a first detection area 210, and the second sensor 120 may detect vehicles entering a second detection area 220. The first detection area 210 and the second detection area 220 may overlap, or the first detection area 210 and the second detection area 220 may be non-overlapping. The size of first detection area 210 and the second detection area 220 may each span an area of the roadway 200, for example, approximately ten feet across. FIG. 2 shows an automobile 250 mostly located within the first detection area 210 and clearly not located within the second detection area 220.

The size of the first and second detection areas 210, 220 may depend on the type of sensor technology being deployed. A second embodiment of a sensor matrix element (described below) having a magnetic sensor may have a smaller detection area, for example, approximately six feet across.

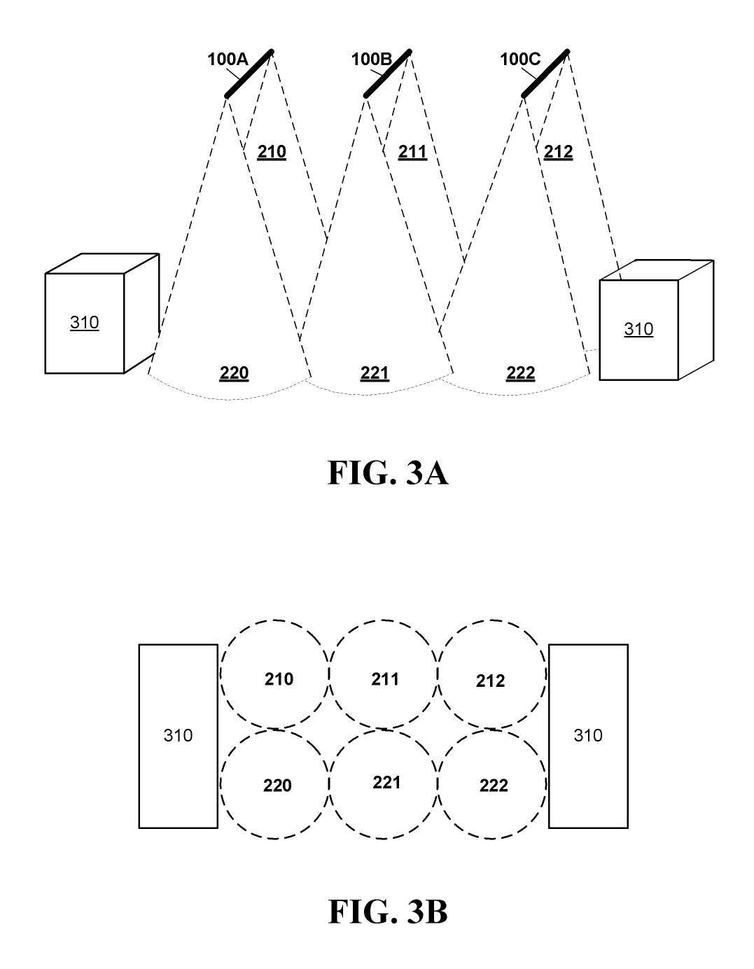

Roadways wider than the sensor detection area may use multiple sensor matrix elements 100 to provide coverage of the full width of the roadway. FIG. 3A shows a first view of a roadway with a directional sensor matrix including three overhead sensor matrix elements 100A, 100B, 100C (referred to together as 100). Note that while three sensor matrix elements 100 are depicted in the first embodiment for exemplary purposes, there is no objection to a directional vehicle sensor matrix configured with more sensor matrix elements 100, or a directional vehicle sensor matrix having as few as one or two sensor matrix elements 100. In FIG. 3A, the sensor matrix elements 100 are oriented so that they are parallel to one another. However, there is no objection to orienting the sensor matrix elements 100 in non-parallel fashion, for example, lining the sensor matrix elements 100 substantially end to end, or to mixing parallel and non-parallel orientation. As depicted in FIG. 3A, the roadway is covered by the three sensor matrix elements 100, having dimensions, for example, approximately thirty feet wide by twenty feet deep, bounded by two physical barriers 310. The physical barriers 310 may be, for example, walls, poles, or other barriers that physically restrict vehicle traffic. Each sensor matrix element 100 has two associated detection areas. The first sensor matrix element 100A is associated with the first and second detection areas 210 and 220, the second sensor matrix element 100B is associated with the first and second detection areas 211 and 221, and the third sensor matrix element 100C is associated with the first and second detection areas 212 and 222.

FIG. 3B is an overhead view of the monitored roadway of FIG. 3A with three overhead sensor matrix elements 100 removed for clarity. As seen in the figure, the six detection areas 210, 211, 212, 220, 221, and 222 of the three overhead elements 100 cover most of the roadway area between the barriers 310, so that vehicles driving between the barriers 310 will be detected by one or more of the overhead sensor matrix elements. The section of roadway between the barriers 310 being monitored by the six detection areas 210, 211, 212, 220, 221, and 222 is collectively called the monitored roadway. The length of the monitored roadway between the barriers 310 is used to determine the number of sensors 100 to be used in the sensor matrix.

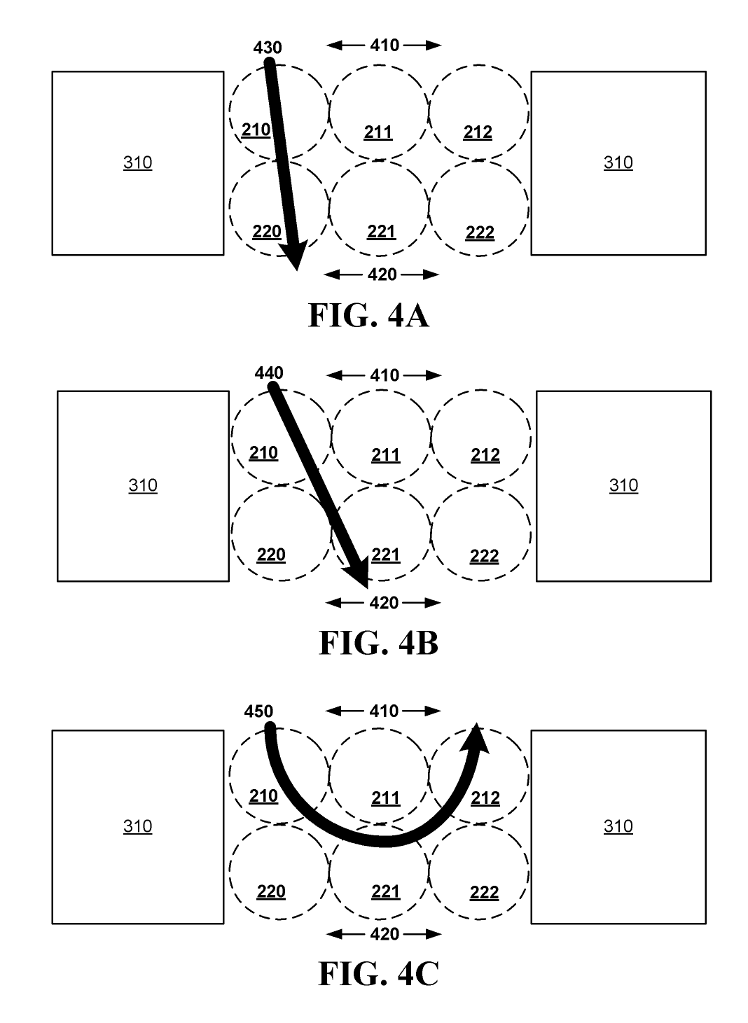

FIGS. 4A, 4B and 4C are simplified diagrams of the monitored roadway depicted in FIG. 3A and FIG. 3B. In FIGS. 4A, 4B and 4C, the monitored roadway is situated between a first vehicle area 410 and a second vehicle area 420. The arrows 430, 440 and 450 indicate the paths of a vehicle (not shown) traversing the monitored roadway. In FIG. 4A, the vehicle (not shown) following the vehicle path 430 enters the first detection area 210 of a first sensor matrix element (not shown) from a first vehicle area 410 and exits the roadway area through the second detection area 220 of the first sensor matrix element into a second vehicle area 420. Since the vehicle path 430 only enters the detection areas 210 and 220 of one sensor matrix element, there is no need for communication between two or more sensor matrix elements to determine the path of the vehicle.

FIG. 4B shows a different path 440 of a vehicle traversing the monitored roadway between the first vehicle area 410 and the second vehicle area 420. The vehicle path 440 intersects the first detection area 210 and the second detection area 220 of the first sensor matrix element, and the second detection area 221 of the second sensor matrix element. Here, the vehicle traverses the detection areas of two sensor matrix elements. Therefore, communication between the two matrix sensor elements may be used to determine the entry and exit points of the vehicle in relation to the monitored roadway as described below.

Similarly, FIG. 4C shows a path 450 traversing the roadway that intersects the first detection area 210 of the first sensor matrix element, the second detection area 221 of the second sensor matrix element, and the first detection area 212 of the third sensor matrix element. Here, the vehicle traverses the detection areas of three sensor matrix elements. Therefore, communication among the three matrix sensor elements is needed to determine the entry and exit point of the vehicle. In FIG. 4C the vehicle enters the first detection area 210 from the first vehicle area 410, and exits the first detection area 212, re-entering the first vehicle area 410.

### USDS Sensor Matrix Element Architecture

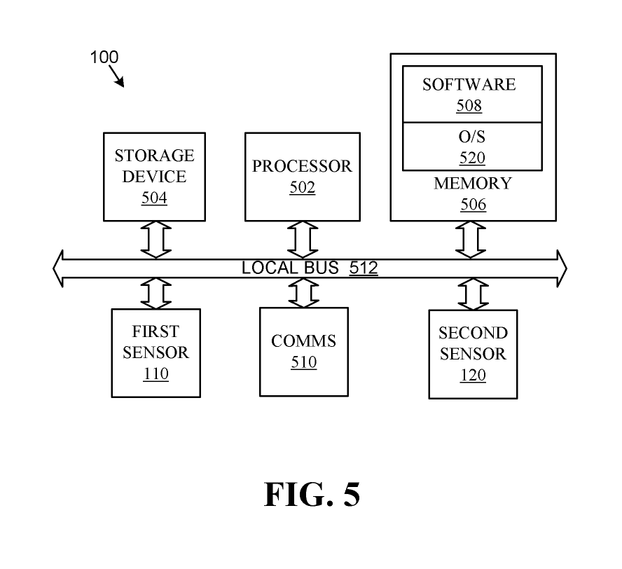

As discussed above, the paths 440 and 450 in FIG. 4B and FIG. 4C traverse the detection areas of two or more sensor matrix elements 100, therefore data from multiple sensor matrix elements 100 may be combined to determine the entry point and exit point of the monitored roadway. FIG. 5 is a simplified block diagram of the functional elements of the sensor matrix element 100, in accordance with the first exemplary embodiment of the invention. A first sensor 110 is in electronic communication with a processor 502 through a local bus 512. Similarly, a second sensor 120 is in electronic communication with the processor 502 through the local bus 512. As discussed previously, the first sensor 110 and the second sensor 120 may be, for example, ultrasound sensors, and/or magnetic field sensors. Under the first embodiment, the ultrasound sensors 110 and 120 may include an ultrasound transmitter and an ultrasound receiver. Note that under the second embodiment, described below, the first sensor 110 and the second sensor 120 may communicate with the processor 502 through a wireless communication channel.

The sensor matrix element 100 contains the processor 502, a storage device 504, a memory 506 having software 508 stored therein that defines the abovementioned functionality, input and output (I/O) devices 510, for example a communications controller (COMMS) 510, and the local bus, or local interface 512 allowing for communication within the sensor matrix element 100. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly software stored in the memory 506. The processor 502 can be any custom made or commercially available single core or multi-core processor, a central processing unit (CPU), an auxiliary processor among several processors associated with the present sensor matrix element 100, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, flash memory, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the sensor matrix element 100, in accordance with the present invention. For example, one task of the software 508 may be to count the number of vehicles entering and exiting vehicle areas, such as the first vehicle area 410 (FIG. 4) and the second vehicle area 420 (FIG. 4) on either side of the monitored roadway. The software 508 in the memory 506 may include one or more separate programs, each of which contains an ordered listing of executable instructions for implementing logical functions of the sensor matrix element 100, as described below. The memory 506 may contain an operating system (O/S) 520. The operating system essentially controls the execution of programs within the sensor matrix element 100 and provides scheduling, input-output control, file and data management, memory management, and communication control and related services.

The communications controller 510 may include input and output ports, for example but not limited to, a USB port, etc. Furthermore, the communications controller 510 may further control devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the sensor matrix element 100 is in operation, the processor 502 is configured to execute the software 508 stored within the memory 506, to communicate data to and from the memory 506, and to generally control operations of the sensor matrix element 100 pursuant to the software 508, as explained above.

Returning to FIG. 4A, a vehicle following path 430 from a first vehicle area 410 through a monitored roadway may first be detected by the first sensor 110 (FIG. 5) of the sensor matrix element 100 (FIG. 5). The first sensor 110 (FIG. 5) may notify the processor 502 (FIG. 5) that there has been a change in state detected in the first detection area 210. In FIG. 5, the first sensor 110 may notify the processor 502 using one of several communications methods known to persons having ordinary skill in the art, including, but not limited to, an interrupt, a semaphore, a mailbox message, and in response to a periodic poll by the processor 502 of the first sensor 110. The notification by the first sensor 110 may include data to be used by the processor 502 to determine information regarding the vehicle. For example, the first sensor 110 may report the round trip time of a transmitted ultrasound signal to be reflected off of the vehicle and received by the first sensor 110. The processor 502 may subsequently execute a function stored in software 508 to calculate the height of the vehicle based upon the data reported by the first sensor 110. Similarly, the processor 502 may associate timing information with the data reported by the first sensor 110, for example, by assigning a time stamp to the data. Alternatively, the first sensor 110 may include a timestamp in the data included in the notification to the processor 502.

As the vehicle proceeds along the path 430 (FIG. 4A), it enters the second detection area 220 (FIG. 4A) corresponding to the second sensor 120. As with the first sensor 110, the second sensor communicates data regarding a change in state in the second detection area 220 (FIG. 4A), using communications methods discussed above. The processor 502 may then compare data from the first sensor 110 with the data from the second sensor 120 to determine that the vehicle was entering the second sensor detection area 220 (FIG. 4A) at the time that the vehicle was within the first sensor detection area 210 (FIG. 4A). As the vehicle continues, it will exit the first detection area 210 (FIG. 4A), and the first sensor 110 will notify the processor 502 that the first detection area 210 (FIG. 4A) is vacant. Finally, the vehicle will exit the second detection area 220 (FIG. 4A), and enter the second detection area 220 (FIG. 4A), and the second sensor 120 will notify the processor 502 that the detection area is vacant.

The processor 502 will therefore have been notified of the progress of the vehicle as it exited the first vehicle area 410 (FIG. 4A), passed through the monitored area, and entered the second vehicle area 420 (FIG. 4A). The processor 502 may therefore increment a count of vehicles exiting the first vehicle area 410 (FIG. 4A) and increment a count of vehicles entering the second vehicle area 420 (FIG. 4A). For example, the first vehicle area 410 (FIG. 4A) may be a parking facility ramp, and the second vehicle area 420 (FIG. 4A) may be a level of a multi-level parking facility. These vehicle counts may be stored within the memory 506 of the sensor matrix element 100. Or the sensor matrix element may transmit this count information to an external device, such as another sensor matrix element, or an external database processor.

Additional information may be derived from the raw sensor data. For example, the height and length of the vehicle may be determined based upon the timestamp information and physical dimensions of each detection area 210, 211, 212, 220, 221, 222 (FIG. 4A) and the spacing between the first detection area 210 (FIG. 4A) and the second detection area 220 (FIG. 4A). This data may also be used to derive the speed of the vehicle as it passes through the monitored roadway. For example, the height of a vehicle may be calculated by measuring the amount of time measured for a sound wave to be transmitted from a sensor and be reflected back to the sensor. In particular, the sound propagation speed of 333.4 m/s is multiplied by the time duration between sending and receiving a sonic signal to determine the round trip time of the sonic signal.

The speed of the vehicle may be calculated by dividing the distance between the detection areas of two sensor elements by the time between the vehicle detection events at the two sensors. The length of the vehicle may be estimated based upon the amount of time a vehicle is present in the detection area of a sensor element, given the calculated speed of the vehicle.

In some scenarios, a second vehicle may be following closely behind a first vehicle through the detection area. This is known as the tailgating scenario. Under the first embodiment, tailgating may be detected depending upon the speed and separation of the first and second vehicle. For example, if the sampling rate of the USDS is 100 ms, the sensor matrix may detect a gap between two vehicles traveling up to approximately 10 miles per hour. A faster sampling rate may be able to detect smaller gaps, or similarly sized gaps between vehicles traveling at higher speeds.

While the path 430 of FIG. 4A traverses the detection areas associated with a single sensor matrix element, the path 440 (FIG. 4B) traverses the detection areas associated with two sensor matrix elements, and the path 450 (FIG. 4C) traverses the detection areas associated with three sensor matrix elements. Therefore, data from two or more sensor matrix elements may be correlated to plot the course of the vehicle through the monitored area.

Master/Slave

Returning to FIG. 5, under the first embodiment of the directional sensor matrix, multiple sensor matrix elements 100 may communicate with each other via the communications controller 510. The sensor matrix element 100 may transmit raw data collected by the first sensor 110 and the second sensor 120. Similarly, the sensor matrix element 100 may transmit data derived from local sensor data by the processor 502, as described above. The multiple sensor matrix elements 100 within the sensor matrix may exchange this data to compile and derive information regarding vehicle traffic through the roadway monitored by the directional sensor matrix as a whole.

The processors 502 in the multiple sensor matrix elements 100 may partition the computation tasks using distributed processing techniques. Alternatively, the multiple sensor elements 100 may utilize one sensor matrix element 100 as a master element, while the other sensor matrix elements act as slave elements. Under such a master/slave arrangement, the master element processor 502 accumulates data collected by local (internal) sensors 110 and 120, as well as from remote (slave) sensor matrix elements. The master element processor 502 thereafter calculates and accumulates information from local and remote sensors within the directional sensor matrix to determine traffic flow through the monitored roadway, as described further below. The master element may also communicate the status of the directional sensor matrix externally, such as to a remote server, or to additional directional sensor matrixes. The first embodiment of the directional sensor matrix uses a master/slave arrangement.

In the first embodiment, one sensor matrix element 100 is pre-configured to be the master. Such pre-configuration may be accomplished by hardware means, for example, by setting a jumper or DIP switch on the master sensor matrix element 100. The master may also be pre-configured by software or firmware, for example, by writing a flag or semaphore into the local memory 506 of the sensor matrix element. However, there is no objection to having no pre-configured master, where instead the sensor matrix elements 100 are configured to negotiate a master at run time, for instance, at start-up, or to having the sensor matrix elements 100 dynamically allocate the master element based upon run-time parameters, for example, allocating the sensor matrix element 100 with the most available processor or communications bandwidth as the master.

In the first embodiment, the master sensor matrix element 100 has the same physical and electronic attributes as the slave matrix elements 100. However, there is no objection to having the master sensor matrix element 100 configured differently from slave sensor matrix elements 100, for example, with the master having additional processing capacity, memory capacity, or communication bandwidth or range.

A master sensor matrix element 100 may perform a superset of the functions performed by a slave sensor matrix element 100. For example, both master and slave elements may monitor their local sensors 110 and 120 for the presence of vehicles in their associated sensor fields 210 and 220 (FIG. 2). However, the master element may perform additional tasks, such as time synchronization between the sensor matrix elements, collection of data from the slave matrix elements, calculation of parameters based on data accumulated both locally and from slave sensor matrix elements, and communicating with external devices.

Note that in alternative embodiments, the additional functions performed by the master sensor matrix element may be performed by an external device. In other words, each of the sensor matrix elements 100 acts as a slave, and the functions of the master (e.g., synchronization, accumulating data and calculating derived statistics) may be performed by an external device.

Synchronization

Some of the calculations performed by the processor 502 of the master sensor matrix element 100 may make use of the relative collection times of data from the first sensor 110 and the second sensor 120 of local and remote sensor matrixes 100. Therefore, the master sensor matrix element 100 may synchronize clock information with the slave sensor matrix elements. Methods of synchronizing remote processors and processes are known to persons having ordinary skill in the art of data communications. Under the first embodiment, master/slave synchronization is maintained by the master sensor matrix element 100 transmitting a periodic synchronization pulse to all slave sensor matrix elements 100 in the directional sensor matrix.

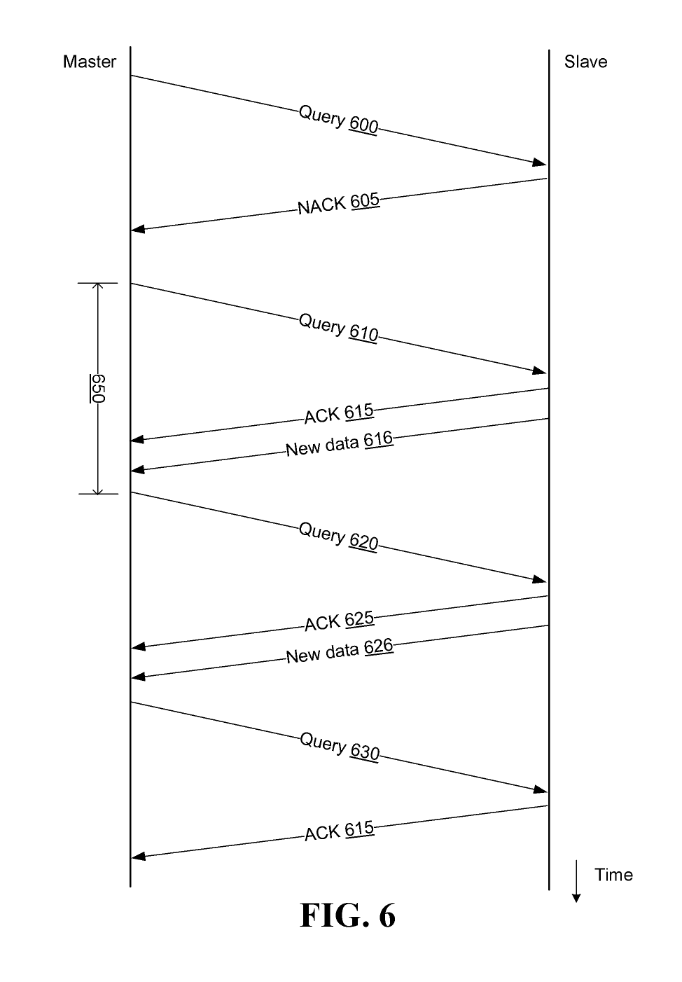

FIG. 6 is a timing diagram showing an example of synchronization messages between a master and a slave. The master transmits a query message, or tact message, periodically, for example, every 100 ms to all slaves. Note, however, there is no objection to configuring a query message period 650 to a longer or shorter interval. The master transmits a query message 600 to a slave. Around the same time, the processor 502 (FIG. 5) on the master sensor matrix element 100 (FIG. 5) polls the status of local sensors 110 (FIG. 5) and 120 (FIG. 5). When the slave sensor matrix element 100 (FIG. 5) receives the query message 600, the processor 502 (FIG. 5) of the slave sensor matrix element 100 (FIG. 5) similarly polls the status of the sensors 110 (FIG. 5) and 120 (FIG. 5) on the slave sensor element 100 (FIG. 5). If the status of sensors 110 indicate that there is not an object within the detection fields 210 and 220 (FIG. 2) the processor 502 (FIG. 5) responds with a negative acknowledgement (NACK). The slave sensor matrix element processor 502 (FIG. 5) may then format a negative acknowledgement message 605, which the slave may transmit to the master, for example, by passing the negative acknowledgement message from the processor 502 (FIG. 5) to the communications controller 510 (FIG. 5). The slave communications controller 510 (FIG. 5) transmits the NACK message 605 to the master.

The master transmits a second query 610 to the slave. The slave again polls the local sensor status and this time determines that an object has been sensed within one of the sensor detection areas. The slave responds to the second query 610 with a positive acknowledgement (ACK) message 615. Thereafter, the slave transmits sensor data to the master in a data message 616. The data in the data message 616 may include, for example, raw sensor data, and it may include derived data calculated by the processor of the slave sensor matrix element, for example, vehicle height.

Note that there is no objection to merging ACK message 615 with the data message 616, so that a single message from the slave to the master includes both an acknowledgement field and a data field. Similarly, there is no objection to the data message 616 being broken up into multiple messages containing data for the master to process. In the embodiment shown in FIG. 6 the slaves send data to the master autonomously after receiving a query message and retrieving and calculating data. In other embodiments, as described below, the slave may merely collect and derive parameters upon receipt of the query message, but the slave will not transmit the parameters to the master until the slave receives a transmit data signal from the master. Of course, there are many variations of synchronization and handshaking between a master and slave familiar to a person having ordinary skill in the art that fall under the scope of this disclosure.

Given that the query message period 650 interval is short relative to the amount of time an object may remain within the detection area of a sensor, it is likely that after an object has moved into the detection area that it will remain within the detection area for many consecutive subsequent queries. FIG. 6 reflects this, as the response to the query message 620 is an ACK message 625, followed by a data message 626 from the slave to the master. The slave will similarly respond to subsequent query messages from the master with ACK and data messages until no objects are detected within the slave detection fields, whereupon the slave will respond to the master query message with a NACK message (not shown).

The fields within the data messages may include various parameters, for example, but not limited to, the status of the sensor, a sensor version identifier, and the current contents of either hardware or software counter registers. Other methods of synchronization among the sensor matrix elements are permissible within the scope of this disclosure. For example, an external device may generate and transmit a clock signal, so that all sensor matrix elements are synchronized to the external clock. Similarly, there may be no need for a slave to wait for a query message to poll the status of sensor elements. Instead, a sensor may interrupt the local processor when a change in sensor status is detected, and likewise a slave element may asynchronously transmit a message to the master element when the slave has fresh raw or derived data available.

Slave Communication ID Tags

The sensor matrix elements may have distinct identifiers so that the recipient of a message can identify the transmitting sensor matrix element. A sensor matrix element may learn its identification number (ID), for example, by reading the ID from a hardware register, or it may engage in a discovery protocol upon start up. Examples of pre-configured IDs include jumpers and DIP switches, while examples of discovery protocols include Address Resolution Protocol (ARP) or Dynamic Host Configuration Protocol (DHCP).

System

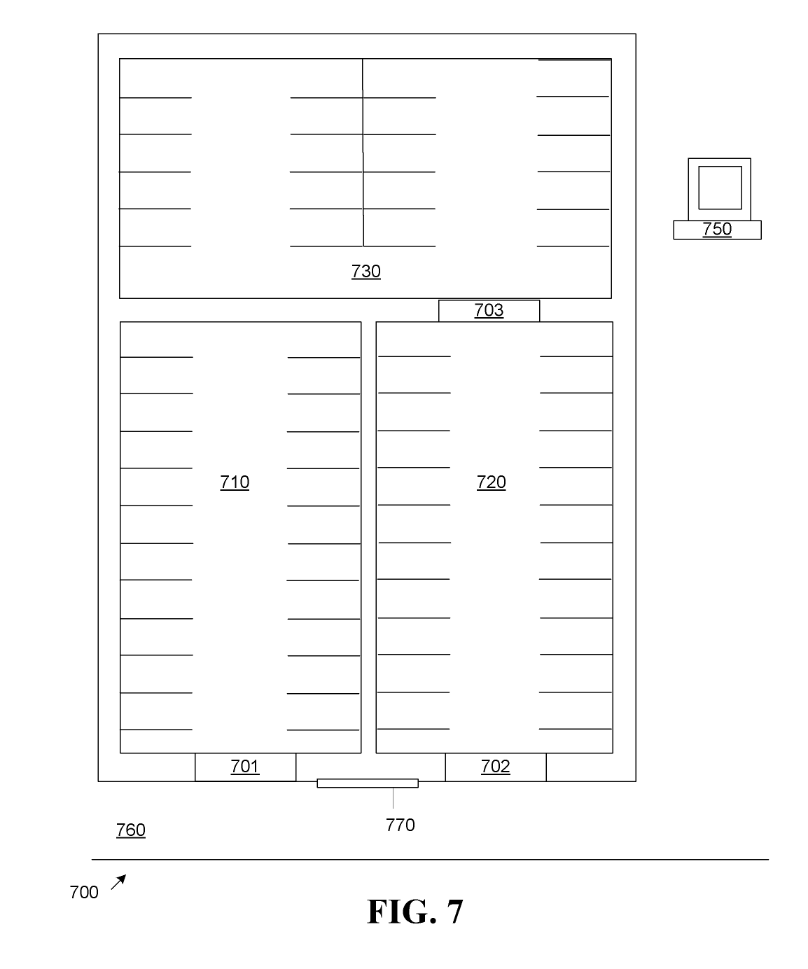

FIG. 7 shows a first embodiment of a parking garage monitoring system 700 with multiple directional vehicle sensor matrixes 701, 702 and 703. Vehicles may enter a first parking area 710 or a second parking area 720 from a roadway 760. Similarly, vehicles may pass between the second parking area 720 and a third parking area 730. A first directional vehicle sensor matrix 701 detects vehicles passing between the roadway 760 and the first parking area 710. A second directional vehicle sensor matrix 702 detects vehicles passing between the roadway 760 and the second parking area 720. A third directional vehicle sensor matrix 703 detects vehicles passing between the second parking area 720 and the third parking area 730. The directional vehicle sensor matrixes 701, 702 and 703 are in communication with a vehicle area manager 750. The vehicle area manager 750 may be, for example, a personal computer (PC) with communications peripherals, for example, a wireless network card.

Each directional vehicle sensor matrix 701, 702 and 703 may be configured to count the number of vehicles entering and exiting one or more adjacent parking areas 710, 720 and 730. For example, because the first parking area 710 has a single portal providing vehicle access, the directional vehicle sensor matrix 701 may record the number of vehicles currently occupying the first parking area 710. The first directional vehicle sensor matrix 701 may then communicate such a vehicle count to the vehicle area manager 750, and the vehicle area manager may use this data to calculate the number of unoccupied parking spaces in the first parking area 710. The vehicle area manager 750 may then transmit this information to a display unit 770, thereby communicating the availability of parking spaces within the first parking area 710 to drivers of vehicles in the roadway 760. The display unit is a device configured to visually communicate information, and may be, but is not limited to, an electronic sign, a personal computer, or a mobile communications device. Note that in the case of the first parking area 710 and the third parking area 730, there is a single portal for each parking area. Therefore, the first directional vehicle sensor matrix 701 and the third directional vehicle sensor matrix 703 may transmit the parking area capacities of the first parking area 710 and the third parking area 730 directly to the display unit 770.

In contrast, the second parking area 720 has two portals, so the second directional vehicle sensor matrix 702 will not account for all the vehicles in the second parking area 720 since some vehicles may have exited the second parking area 720 into the third parking area 730. Therefore, an accurate count of vehicles in the second parking area 720 may require information from both the second directional vehicle sensor matrix 702 and the third directional vehicle sensor matrix 703. Such a count may be performed by the vehicle area manager 750, which may then transmit this count to the display unit 770. Alternatively, there is no objection to the second directional vehicle sensor matrix 702 communicating with the third directional vehicle sensor matrix so they may reconcile their vehicle counts. In other words, the second directional vehicle sensor matrix 702 may subtract the count received from the third directional vehicle sensor matrix 703 to determine the number of vehicles within the second parking area 720.

Many variations of the parking garage monitoring system 700 are possible. For example, directional vehicle sensor matrixes may count vehicles passing through portals for roadways other than parking areas, such as a parking garage access ramp. Or a traffic area manager 750 may communicate with directional vehicle sensor matrixes in separate parking facilities. There may be embodiments where multiple traffic area managers 750 are in communication with multiple display units 770.

Master and Slave Matrix Element Process Flow

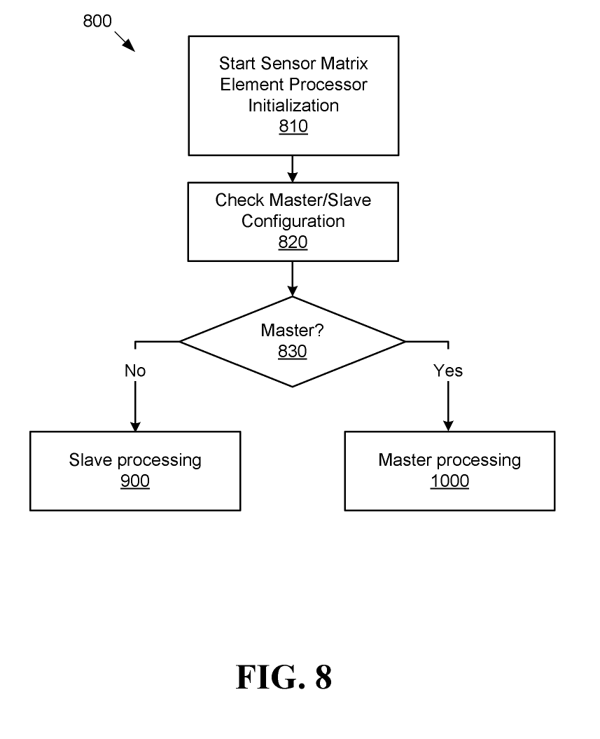

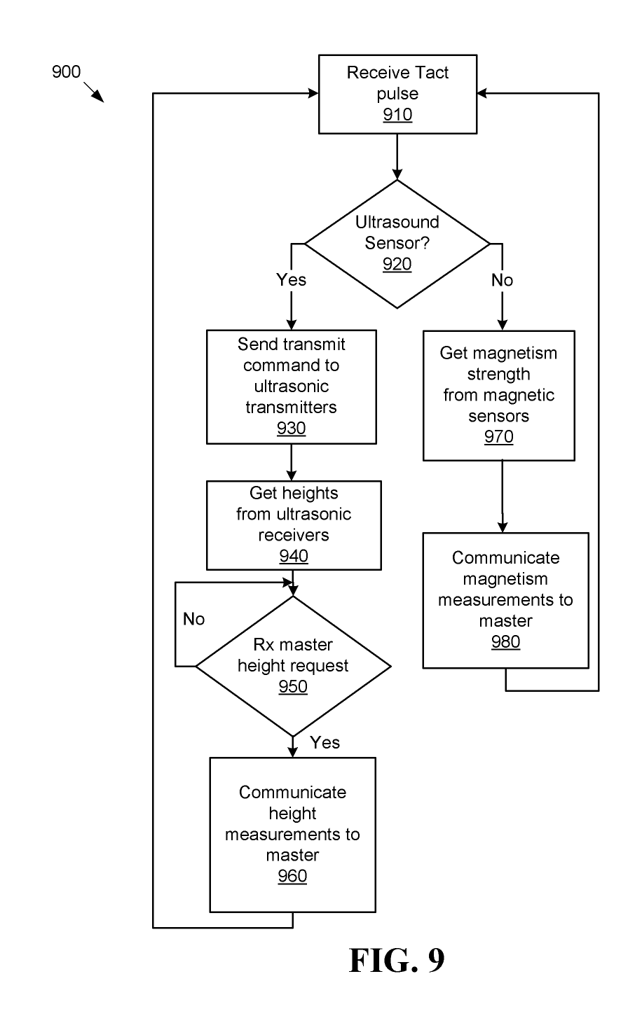

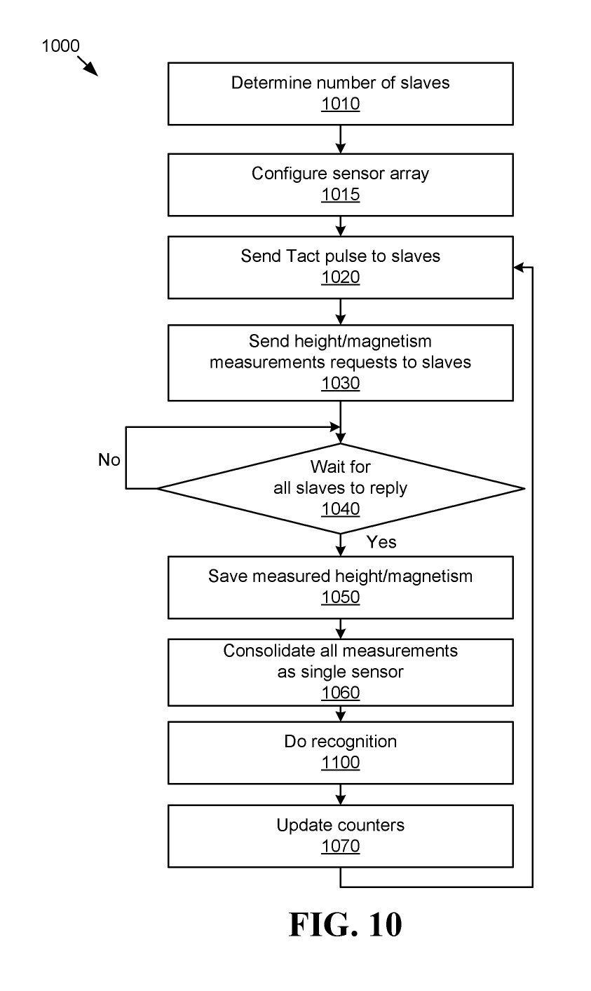

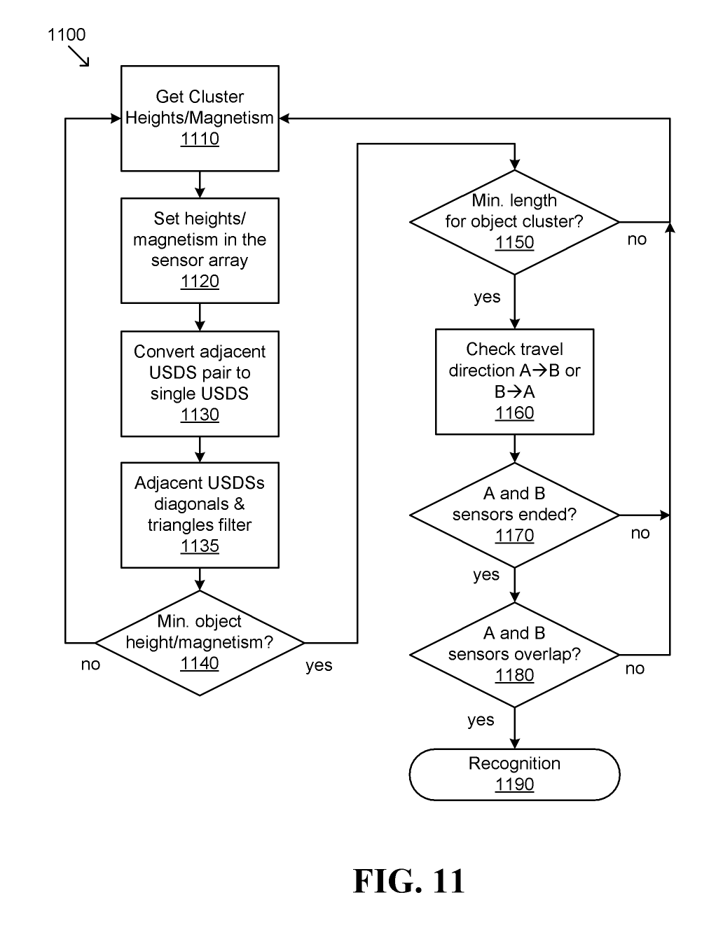

FIG. 8, FIG. 9, FIG. 10 and FIG. 11 are flow charts depicting the processing in master and slave matrix elements. It should be noted that any process descriptions or blocks in flow charts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

FIG. 8 is a flow chart 800 of the initial startup processing of a sensor matrix element. Initialization begins at block 810. The master/slave configuration of the sensor element is checked at block 820. As mentioned above, the sensor matrix element may be pre-configured to be a master or slave sensor matrix element, or the sensor matrix elements may negotiate a master sensor matrix element upon startup. At block 830 the processing branches depending upon whether the sensor matrix element is a master or slave. If the sensor matrix element is a slave, the processing proceeds to slave processing flow chart 900 (FIG. 9). If the sensor matrix element is a master, the processing proceeds to master processing flow chart 1000 (FIG. 10).

FIG. 9 is a flow chart 900 of the processing in a slave unit. At block 910, the slave receives a tact pulse from the master. As described above, the tact pulse both triggers processing in the slaves and acts as a mechanism to synchronize the sensors so that sensor measurements are made concurrently across multiple sensor matrix elements. At block 920 the processing branches depending upon the type of sensor being used in the sensor matrix element. In the first embodiment, the sensor matrix elements use ultrasonic sensors, so the processing branches to block 930. In other embodiments, such as the second embodiment (described below), the processing branches to block 970.

At block 930 the sensor matrix element sends a command to the ultrasonic transmitters, or transceivers, to transmit an ultrasound pulse. The sensor transmits the ultrasound pulse, and the reflected pulse is received by the ultrasonic transceiver. At block 940 the distance between the ultrasonic transceiver and the surface the pulse reflects from is calculated by the local processor as described above. At block 950 the slave sensor matrix element receives a request from the master to transmit the calculated height information from the slave to the master. At block 960 the slave communicates the requested measurements to the master. The processing thereafter remains dormant until another tact pulse is received from the master.

Block 970 describes the processing for slave sensor matrix elements having non-ultrasonic sensors, for example, magnetic sensors. The processor reads the magnetic strength from the first magnetic sensor and the second magnetic sensor. At block 980, the processor communicates the magnetism measurements to the master. The processing thereafter remains dormant until another tact pulse is received from the master. Note that while the block diagram 900 does not show the slave receiving a transmit request from the master, there is no objection to slave elements in an embodiment with magnetic sensors similarly holding off on transmitting sensor data to the master until the slave receives a transmission request from the master.

In flow chart 900, the processing in the slaves is event driven by messages from the master. However, there is no objection to other mechanisms driving the collection of data from the sensors, such as, for example, an external clock signal. Similarly, there is no objection to processing being driven by other events, for example, changes in sensor readings.

FIG. 10 is a flow chart 1000 of the processing in the master sensor matrix element. At block 1010 the master determines the number of slave sensor matrix elements. For example, if the roadway being monitored is relatively narrow, there may be a single slave sensor matrix element. For a wider monitored roadway, there may be two or more slave sensor matrix elements associated with the master sensor matrix elements. At block 1015, the master element initializes and configures a sensor array, or other similar data structure, to store and handle data communicated by the slave sensor matrix elements. The size of the array is determined by the number of slaves discovered at block 1010. Upon completion of this sensor array configuration, the master begins to periodically transmit tact pulses to the slaves, as described above.

The tact pulse period may be, for example, 100 ms. Shorter tact pulse periods may be selected, for example, to provide greater resolution for detecting vehicles traveling at higher speeds, or for detecting vehicles traveling very close behind one another. However, a shorter pulse period results in increased power consumption and additional processing of the more frequent reply messages. Similarly, longer tact pulse periods may be elected, for example 120 ms. Such longer periods may result in lower power consumption and reduced processing loads, but similarly may result in reduced tracking resolution of the sensor matrix, making it more difficult to track faster moving or close trailing traffic.

At block 1020 the master sends a tact pulse to the slave sensor matrix array elements to trigger collection of sensor information in the slaves (see above discussion of FIG. 9). At block 1030 the master may send a message to the slave sensor matrix elements requesting they transmit sensor data. The sensor data may be height measurements for ultrasonic sensors, or magnetism strength for magnetic sensors. The time between the transmission of the tact pulse of block 1020 and the transmission of the measurement requests of block 1030 may be tuned based upon factors such as the processing speed of the slave sensor matrix elements, but is less than the time of the tact pulse period. The master waits for reply messages from each of the slaves at block 1040.

At block 1050, the master stores the measurements collected from the slaves in the sensor array that was configured at block 1015. The data is consolidated at block 1060, so that the processing may continue as if the data from the separate sensor matrix elements had been collected within as single device. Recognition processing is performed at block 1100, which is described in detail below. At block 1070 counters are updated. For example, the number of vehicles currently present in a first parking area may be recorded in a first counter register, and the number of vehicles present in a second parking area may be recorded in a second counter register.

Vehicle Path Recognition Processing

FIG. 11 is a block diagram 1100 of the vehicle direction recognition processing performed in the master sensor matrix element. Block 1110 performs similar function of blocks 1030 (FIG. 10) and 1040 (FIG. 10) in gathering the sensor data from the sensors local to the master sensor matrix elements, and, at block 1120, storing the local sensor data in the sensor array. At block 1130, the local sensor data is converted so the data in the sensor array may be treated as collected by a single device. Such conversion may be, for example, correlating data in time and scaling data so that relative measurements of individual sensor matrix elements are normalized across all sensor matrix elements. The data in the sensor array may be arranged, for example, as depicted in Table 1:

TABLE 1

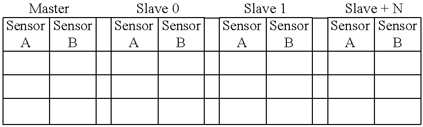

Each row of Table 1 may represent, for example, the height of each ultrasonic sensor in the sensor matrix as measured at a single window of time. Subsequent rows may represent the heights during subsequent measurement windows. Note that for magnetic sensors, the data in the sensor matrix would represent magnetism strength, rather than height. Each column of Table 1 may represent a single sensor. Pairs of sensors within a single sensor matrix element are demarked by double lines.

At step 1135 the processor compares the table entries of adjacent sensors, as determined by the physical sensors in the array matrix. For example, detection of objects in Sensor A of Slave 0 and Sensor A of Slave 1 (Table 1) may indicate a vehicle traveling from the detection areas of Sensor A Slave 0 to the detection area monitored by Sensor A of Slave 1. The direction of the vehicle may be determined by monitoring these two adjacent array elements over time. For example, if in subsequent time windows, the object is no longer detected by Sensor A of Slave 0, the direction of the vehicle may be determined to be in the direction from Sensor A of Slave 0 to the detection area of Sensor A of Slave 1. This is further discussed below.

At block 1140 the parameters stored in the sensor array are compared to minimum threshold levels to determine whether the corresponding sensors are detecting a vehicle or a non-vehicle. For example, a minimum vehicle height threshold of five feet may be used to determine whether a vehicle is present. Height readings less than the threshold height are filtered out, and the detection area is considered vacant in additional processing for that array element during this time window (or table row).

The master processor groups the sensor elements according to geometry to detect a vehicle passing between adjacent sensors. For example, the master processor may monitor whether objects exceeding the threshold height are passing from Sensor A of Slave 1 to Sensor B of Slave 1. Similarly, the master processor may monitor whether the object is traveling from Sensor A of Slave 1 to Sensor A of Slave 2, or Sensor B of Slave 2. In contrast, the master processor may not group sensors of Slave 1 with sensors of Slave 3, as the corresponding detection areas of these two sensor matrix elements are not physically adjacent. Therefore, for a given sensor, there are at most five adjacent sensors that the master must monitor to determine the direction of the object detected by the sensor. In some cases, for example, for a sensor adjacent to a physical obstruction such as a wall or concrete barrier, the master processor must only process three adjacent sensors to detect the travel direction of a detected object. The master object is configured to process only groupings of sensor array elements corresponding to physically adjacent sensors. This reduces the amount of processing performed in the master.

Similarly, at block 1150, the master processor filters out objects that are not long enough to be a vehicle. The determination of the length of a sensed object is described above. If the sensed object falls below the minimum length threshold, no further processing is performed to determine the direction of travel of the object.

At block 1160 the processor walks through the adjacent pairings of sensors and compares the measurements of the current time window with the measurements of previous time windows to determine the direction of the object. For example, for a pair of sensors A and B, the current and previous time windows are compared to determine if an object detected in both sensors A and B is traveling in the direction from A to B, or if the object is traveling in the direction from B to A. This may be determined by evaluating which sensor detected the object first. The master processor thereafter sets a direction flag.

At block 1170, the master processor determines whether an object has moved between adjacent blocks in subsequent time windows. For example, if an object is detected by sensor A and no object is detected by sensor B in a first time window, and no object is detected by sensor A in a second time window and an object is detected by sensor B in the second time window, the master processor will assume that the objects being tracked by sensor A and sensor B are not the same object. This is because an object large enough to be a vehicle passing between sensor A and sensor B would be long enough that it would have to be simultaneously detected by sensor A and sensor B for a minimum number of time windows between the time the vehicle left the detection area of sensor A and the vehicle enters the detection area of sensor B.

If, however, both sensor A and sensor B simultaneously detect an object that was initially detected by only sensor A or sensor B, as per block 1180, the master processor decides that it has recognized a vehicle and the direction of that vehicle at block 1190. Subsequently, when the detected vehicle passes from all of the sensor element detection fields, the vehicle is declared to have entered a parking area, and the count for that parking area is incremented as per block 1070 (FIG. 10). The parking area is identified as the parking area adjacent to the last sensor area where the vehicle was detected. Similarly, the count for the parking area where the vehicle was initially detected to be entering the sensor area from is decremented.

Magnetic Sensor Embodiment

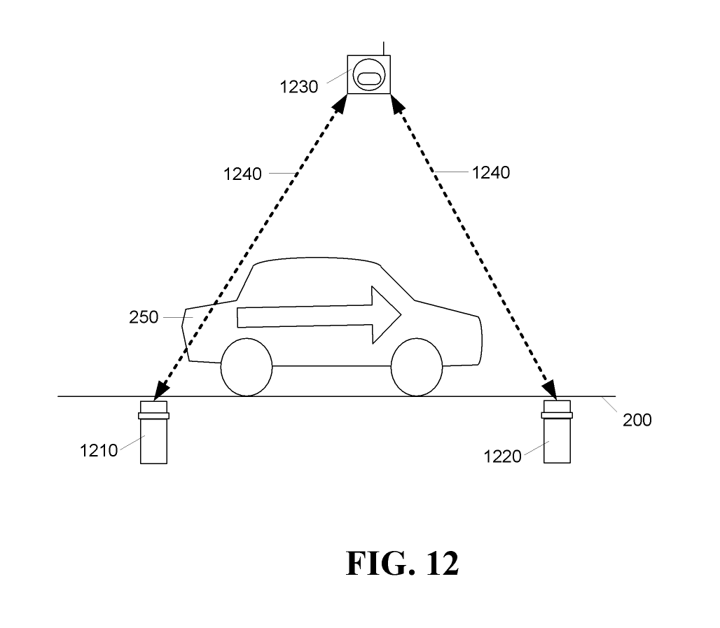

A second embodiment of a sensor matrix element is pictured in FIG. 12. Under the third embodiment, the sensor matrix element may have a first sensor 1210 and a second sensor 1220 mounted beneath a roadway surface 200. For example, the first sensor 1210 and the second sensor 1220 may be magnetic sensors. The sensor matrix element has a processor 1230. Under the second embodiment, the processor 1230 is housed independently of the first sensor 1210 and the second sensor 1220 and communicates wirelessly with the first sensor 1210 and the second sensor 1220. However, there is no objection to having the processor 1230 housed with either the first sensor 1210 or housed with the second sensor 1220. Similarly, there is no objection to the processor 1230 communicating with the first sensor 1210 and the second sensor 1220 with hard wired communication. The wireless communication between the processor 1230 and the sensors 1210 and 1220 are shown by dashed lines 1240.

Under the second embodiment, the sensors 1210 and 1220 use three mutually perpendicular magnetoresistive transducers, with each transducer detecting magnetic field changes along one axis. Incorporating three sensing elements produces significant sensor sensitivity. Other types of magnetic sensors are also possible, for example, an in-ground inductive loop.

A ferrous object on the roadway 200 may alter the local, or ambient, magnetic field surrounding the object, in this case the automobile 250. The magnitude of this magnetic field change depends upon the various parameters of the object. Examples of these parameters include size, shape, orientation, and composition. Similarly, the magnitude of the magnetic field may change depending upon the ambient magnetic field strength and orientation of the sensors 1210 and 1220.

The magnetic sensors 1210 and 1220 may be programmed to measure the ambient magnetic field. When a large ferrous object, such as the automobile 250, alters that magnetic field, the sensors detects the magnetic field changes, or anomalies. In contrast with the ultrasound sensors of the first embodiment, the magnetic sensors do not detect vehicle height. Instead of using the height of the detected object, the magnetic sensors 1210 and 1220 may detect the strength of the magnetic response to differentiate between a vehicle and a non-vehicle, for example, a pedestrian or shopping cart. The magnetic sensor may employ a minimum threshold trigger level, so that events triggered by non-vehicles are not reported to the processor. When the degree of magnetic field change reaches the threshold of the sensor, the sensor reports a change of state to the processor. Alternatively, the magnetic sensor may report all events to the processor, but the processor may only perform vehicle tracking on events where the magnetic signal exceeds a configurable threshold.

As with the first embodiment, each sensor matrix element under the second embodiment may be configured as a master or a slave. The slave sensor matrix elements transmit data to the master sensor matrix element. The vehicle speed and direction processing is performed in the master as described above, with the strength of the magnetic field substituted for the vehicle height parameter as used by the first embodiment.

The ultrasound sensors of the first embodiment transmit a signal and wait to receive the reflection of that signal off of, for example, a roadway or a vehicle. Therefore, there is a delay inherent in an ultrasound embodiment between the time a vehicle enters the detection area and when the sensor becomes aware of its presence due to the propagation speed of the ultrasound signal. In contrast, the magnetic sensor implementation of the second embodiment may have a faster detection time, as the magnetic sensors have no corresponding propagation delay.

The second embodiment also differs from the first embodiment in that the processor 1230 does not have to be physically positioned above the monitored roadway. Because the sensors 1210 and 1220 and the processor 1230 are not necessarily co-located in the second embodiment, the processor 1230 need only be positioned so it may communicate with the sensors 1210 and 1220. As mentioned previously, this communication may be through a hard-wired connection or a wireless communication link. While the sensor matrix element of the second embodiment is not typically a single physical unit as with the first embodiment, the sensor matrix element of the second embodiment is similar to the first embodiment in that both encompass two sensors in communication with a processor. The second embodiment is also similar to the first embodiment in that a full sensor matrix is made up of multiple sensor matrix elements, with one sensor matrix element configured as a master with the remaining sensor matrix elements configured as slaves.

### Additional Embodiments

The first embodiment of the sensor matrix element uses ultrasonic sensors, and the second embodiment of the sensor matrix element uses magnetic sensors. There may be situations where it is desirable to combine sensor technologies within as single sensor matrix. For example, there may be a parking area where it is impractical to embed a magnetic sensor below the roadway for a portion of the monitored roadway, and another portion of the monitored roadway where an overhead ultrasound is similarly impractical. In such situations, a third embodiment of the sensor matrix may be composed of both a magnetic sensor matrix element and an ultrasound sensor matrix element. Of course, the processing of data of such a multiple sensor technology element would take into account the differences in sensor data when determining when a vehicle has passed from a first sensor detection area to a second sensor detection area.

In summary, an apparatus, method, and system for detecting and counting vehicles on roadways has been presented. The apparatus includes a directional vehicle sensing matrix containing at least two sensor elements, each sensor element having two sensors, a processor and a communications port. The sensor elements communicate within the matrix to count vehicles entering and exiting a roadway monitored by the matrix. The matrix may be part of a traffic monitoring system including a traffic manager and a display unit.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for detecting a vehicle traversing a non-partitioned monitored roadway comprising:
a first sensor matrix element comprising:
a first sensor matrix element first sensor monitoring a first detection area within the monitored roadway, the first sensor matrix element first sensor configured to communicate sensor data;
a first sensor matrix element second sensor monitoring a second detection area within the monitored roadway, the first sensor matrix element second sensor configured to communicate sensor data, the second detection area being substantially adjacent to the first detection area;
a first sensor matrix element processor in communication with the first sensor matrix element first sensor and the first sensor matrix element second sensor; and
a first sensor matrix element transceiver in communication with the first sensor matrix element processor; and
a second sensor matrix element in communication with the first sensor matrix element, the second sensor matrix element comprising:
a second sensor matrix element first sensor monitoring a third detection area within the monitored roadway, the second sensor matrix element first sensor configured to communicate sensor data, the third detection area being substantially adjacent to the first detection area.
a second sensor matrix element second sensor monitoring a fourth detection area within the monitored roadway, the second sensor matrix element second sensor configured to communicate sensor data;
a second sensor matrix element processor in communication with the second sensor matrix element first sensor and the second sensor matrix element second sensor; and
a second sensor matrix element transceiver in communication with the second sensor matrix element processor.

2. The vehicle detecting apparatus of claim 1, wherein, the first sensor matrix element is configured to transmit sensor data to the second sensor matrix element.

3. The vehicle detecting apparatus of claim 2 wherein the first sensor matrix element is configured as a slave and the second sensor matrix element is configured as a master.

4. The vehicle detecting apparatus of claim 3, wherein the first sensor matrix element is in wireless communication with the second sensor matrix element.

5. The vehicle detecting apparatus of claim 3, wherein the first sensor matrix element is in wired communication with the second sensor matrix element.

6. The vehicle detecting apparatus of claim 3, wherein the first sensor matrix element is configured to be mounted above the first detection area and the second detection area.

7. The vehicle detecting apparatus of claim 6, wherein the first sensor matrix element first sensor comprises an ultrasonic sensor.

8. The vehicle detecting apparatus of claim 7, wherein the first sensor matrix element first sensor and the first sensor matrix element second sensor are contained within a single housing.

9. The vehicle detecting apparatus of claim 3, wherein the first sensor matrix element first sensor comprises a magnetic field sensor.

10. The vehicle detecting apparatus of claim 9, wherein the magnetic field sensor is mounted beneath the monitored roadway.

11. The vehicle detecting apparatus of claim 10, wherein the magnetic field sensor communicates wirelessly with the first sensor matrix element processor.

12. The vehicle detecting apparatus of claim 11, wherein the first sensor matrix element first sensor and the first sensor matrix element second sensor are not housed within a single enclosure.

13. A method for directionally detecting vehicles traversing a non-partitioned monitored roadway between a first vehicle area and a second vehicle area, comprising the steps of:
providing a first sensor matrix element within the monitored roadway, the first sensor matrix element comprising a first sensor matrix element first sensor and a first sensor matrix element second sensor;
providing a second sensor matrix element within the monitored roadway, the second sensor matrix element comprising a second sensor matrix element first sensor and a second sensor matrix element second sensor;
establishing a communications link between the first sensor matrix element and the second sensor matrix element;
detecting a vehicle with the first sensor matrix element;
detecting the vehicle with the second sensor matrix element;
transmitting vehicle detection data from the first sensor matrix element to the second matrix element;
correlating vehicle detection data from the first sensor matrix element with vehicle detection data from the second sensor matrix element;
calculating a vehicle entrance location into the monitored roadway; and
calculating a vehicle exit location from the monitored roadway.

14. The method of claim 13, wherein the step of transmitting vehicle detection data is performed wirelessly.

15. The method of claim 13, further comprising the step of calculating a vehicle speed.

16. The method of claim 13, further comprising the step of calculating a vehicle length.

17. The method of claim 13, further comprising the step of calculating a vehicle height.

18. The method of claim 13, further comprising the step of calculating a number of vehicles traversing the monitored roadway.

19. The method of claim 18 wherein the number of vehicles traversing the monitored roadway comprises:
a count of vehicles entering the first vehicle area;
a count of vehicles entering the second vehicle area;
a count of vehicles exiting the first vehicle area; and
a count of vehicles exiting the second vehicle area.

20. The method of claim 19, further configured to perform steps comprising:
discerning a vehicle from a non-vehicle in the monitored roadway.

21. The method of claim 19, further configured to perform the step comprising:
discerning a first vehicle in the monitored roadway from a second vehicle in the monitored roadway, wherein the second vehicle is separated from the first vehicle by at least two feet.

22. A computer readable media configured to perform steps comprising:
receiving a first data message from a local sensor, the local sensor configured to detect a vehicle within a first portion of a non-partitioned monitored roadway;
receiving a second data message from a remote sensor, the remote sensor configured to detect a vehicle within a second portion of the monitored roadway;
correlating the first data message with the second data message; and
calculating a number of vehicles traversing the monitored roadway, wherein the number of vehicles traversing the monitored roadway comprises:
a count of vehicles entering a first vehicle area adjacent to the monitored roadway,
a count of vehicles entering a second vehicle area adjacent to the monitored roadway,
a count of vehicles exiting the first vehicle area, and
a count of vehicles exiting the second vehicle area.

23. The computer readable media of claim 22, further configured to perform steps comprising:
calculating a speed of a vehicle traversing the monitored roadway; and
calculating a length of the vehicle.

24. The computer readable media of claim 23, further configured to perform the step of calculating a height of the vehicle.

25. The computer readable media of claim 22, further configured to perform the step of discerning a vehicle from a non-vehicle in the monitored roadway.

26. The computer readable media of claim 22, further configured to perform the step of discerning a first vehicle in the monitored roadway from a second vehicle in the monitored roadway, wherein the second vehicle is separated from the first vehicle by at least two feet.

27. A method for directionally detecting vehicles traversing a non-partitioned monitored roadway between a first vehicle area and a second vehicle area, comprising the steps of:
providing a first sensor within the monitored roadway, the first sensor comprising a wireless transceiver;
providing a second sensor within the monitored roadway, the second sensor comprising a wireless transceiver;
providing a processor comprising a wireless transceiver;
establishing a communications link between the first sensor and the processor;
establishing a communications link between the second sensor and the processor;
detecting a vehicle with the first sensor;
detecting a vehicle with the second sensor;
transmitting vehicle detection data from the first sensor to the processor;
transmitting vehicle detection data from the second sensor to the processor; and
correlating vehicle detection data from the first sensor with vehicle detection data from the second sensor.

28. The method of claim 27, further comprising the steps of:
calculating a vehicle entrance location into the monitored roadway; and
calculating a vehicle exit location from the monitored roadway.

29. The method of claim 27, further comprising the step of calculating a vehicle speed.

30. The method of claim 27, further comprising the step of calculating a vehicle length.

31. The method of claim 27, further comprising the step of calculating a number of vehicles traversing the monitored roadway.

32. The method of claim 31 wherein the number of vehicles traversing the monitored roadway comprises:
a count of vehicles entering the first vehicle area;
a count of vehicles entering the second vehicle area;
a count of vehicles exiting the first vehicle area; and
a count of vehicles exiting the second vehicle area.

33. The method of claim 32, further configured to perform the step of discerning a vehicle from a non-vehicle in the monitored roadway.

34. The method of claim 32, further configured to perform the step of discerning a first vehicle in the monitored roadway from a second vehicle in the monitored roadway, wherein the second vehicle is separated from the first vehicle by at least two feet.

35. A system for monitoring vehicle presence within a vehicle area comprising:
a first directional vehicle sensor matrix located substantially within a first vehicle area portal, the first directional vehicle sensor matrix comprising:
a first sensor matrix element comprising:
a first sensor matrix element first sensor monitoring a first detection area within the portal, and
a first sensor matrix element second sensor monitoring a second detection area within the portal;
a second sensor matrix element in communication with the first sensor matrix element, the second sensor matrix element comprising:
a second sensor matrix element first sensor monitoring a third detection area within the portal, and
a second sensor matrix element second sensor monitoring a fourth detection area within the portal; and
a vehicle area manager in communication with the first directional vehicle sensor matrix, the vehicle area manager comprising a database, the database comprising a vehicle occupancy count for the vehicle area.

36. The system of claim 35, wherein the first sensor matrix element and the second sensor matrix element communicate wirelessly.

37. The system of claim 35, wherein first directional vehicle sensor matrix and the vehicle area manager communicate wirelessly.

38. The system of claim 35, further comprising a vehicle area display in communication with the vehicle area manager, the vehicle area display configured to display the vehicle occupancy count.

39. The system of claim 38, wherein the vehicle area manager and the vehicle area display communicate wirelessly.

40. The system of claim 38, wherein the first directional vehicle sensor matrix is in communication with the vehicle area display.

41. The system of claim 40, wherein the first directional vehicle sensor matrix and the vehicle area display communicate wirelessly.

42. The system of claim 35, further comprising a second directional vehicle sensor matrix located substantially within a second vehicle area portal.

43. The system of claim 38, wherein the first directional vehicle sensor matrix is in communication with the second directional vehicle sensor matrix.

44. The system of claim 39, wherein the first directional vehicle sensor matrix and the second directional vehicle sensor matrix communicate wirelessly.
